(19) United States
(12) Patent Application Publication
(10) Pub. No.: US 2026/0156399 A1
(43) Pub. Date: Jun. 4, 2026

(54) EARPHONES AND METHODS FOR CONTROLLING EARPHONES

(71) Applicant: SHENZHEN SHOKZ CO., LTD., Shenzhen (CN)

(72) Inventors: Wenbing ZHOU, Shenzhen (CN); Fengyun LIAO, Shenzhen (CN); Xin QI, Shenzhen (CN)

(73) Assignee: SHENZHEN SHOKZ CO., LTD., Shenzhen (CN)

(21) Appl. No.: 19/412,994

(22) Filed: Dec. 9, 2025

Related U.S. Application Data
(63) Continuation of application No. PCT/CN2024/127327, filed on Oct. 25, 2024.

(51) Int. Cl. H04R 1/10; H04R 1/44; H04R 9/02

(52) U.S. Cl. CPC H04R 1/1041; H04R 1/44; H04R 9/025; H04R 2460/13

(57) ABSTRACT

Provided is an earphone. The earphone includes an air conduction vibrator configured to generate an air conduction sound; a bone conduction vibrator configured to generate a bone conduction sound; and a control circuit configured to perform a switching operation among a plurality of working states of the earphone. The plurality of working states of the earphone include at least one of a working state in which the air conduction vibrator operates alone or a working state in which the bone conduction vibrator operates alone.

### CROSS-REFERENCE TO RELATED APPLICATIONS

This application is a Continuation of International Patent Application No. PCT/CN 2024/127327, filed on Oct. 25, 2024, the entire contents of which are incorporated herein by reference.

### TECHNICAL FIELD

The present disclosure relates to the field of acoustic technology, and in particular, to earphones and methods for controlling the earphones.

### BACKGROUND

As a sound generating component in an earphone, a loudspeaker is capable of converting an electrical signal into a sound signal. Typically, according to the sound transmission mode, loudspeakers may be classified into a bone conduction loudspeaker, an air conduction loudspeaker, and a bone-air conduction loudspeaker. The bone conduction loudspeaker generates a bone conduction sound signal. The air conduction loudspeaker generates an air conduction sound signal. The bone-air conduction loudspeaker simultaneously generates a bone conduction sound signal and an air conduction sound signal. However, current earphone products typically only support a fixed type of sound transmission mode, which may limit the application scenarios of the earphones. Taking a loudspeaker in an earphone being an air conduction loudspeaker as an example, when the volume of the environmental noise is large, the air conduction sound signal output by the air conduction loudspeaker may be submerged by the environmental noise, thereby causing unclear listening for a user. When the earphone is immersed in water, the air conduction loudspeaker cannot normally emit sounds.

### SUMMARY

One or more embodiments of the present disclosure provide an earphone, including: an air conduction vibrator configured to generate an air conduction sound; a bone conduction vibrator configured to generate a bone conduction sound; and a control circuit configured to perform a switching operation among a plurality of working states of the earphone. The plurality of working states of the earphone include at least one of a working state in which the air conduction vibrator operates alone and a working state in which the bone conduction vibrator operates alone.

In some embodiments, the plurality of working states of the earphone include a first working state and a second working state. The control circuit is configured to: receive a control signal; and perform switching from the first working state to the second working state in response to the control signal.

In some embodiments, the earphone is provided with a control key, and the control signal originates from an instruction generated by a user operating the control key.

In some embodiments, the first working state is the working state in which the air conduction vibrator operates alone, and the second working state is the working state in which the bone conduction vibrator operates alone.

In some embodiments, the earphone is provided with at least one sensor for detecting at least one environmental parameter, and the control signal originates from a numerical change of the environmental parameter satisfying a first preset condition.

In some embodiments, the environmental parameter includes a liquid weight at a specific position on the earphone, and the first preset condition is that the liquid weight exceeds a first threshold.

In some embodiments, the environmental parameter includes a volume of environmental noise, and the first preset condition is that the volume of the environmental noise exceeds a second threshold.

In some embodiments, the first working state is the working state in which the bone conduction vibrator operates alone, and the second working state is the working state in which the air conduction vibrator operates alone.

In some embodiments, the earphone is provided with at least one sensor for detecting at least one environmental parameter, and the control signal originates from a numerical change of the environmental parameter satisfying a second preset condition.

In some embodiments, the environmental parameter includes a liquid weight at a specific position on the earphone, and the second preset condition is that the liquid weight is less than a third threshold.

In some embodiments, the environmental parameter includes a volume of environmental noise, and the second preset condition is that the volume of the environmental noise is less than a fourth threshold.

In some embodiments, the first working state is a working state in which the bone conduction vibrator and the air conduction vibrator operate simultaneously, and the second working state is the working state in which the bone conduction vibrator operates alone or the working state in which the air conduction vibrator operates alone.

In some embodiments, the first working state is the working state in which the bone conduction vibrator operates alone or the working state in which the air conduction vibrator operates alone, and the second working state is a working state in which the bone conduction vibrator and the air conduction vibrator operate simultaneously.

In some embodiments, the bone conduction vibrator includes a first magnetic circuit, a vibration plate, and a first coil; the air conduction vibrator includes a diaphragm, a second magnetic circuit, and a second coil. An angle between a first vibration direction of the vibration plate in the first magnetic circuit and a second vibration direction of the diaphragm in the second magnetic circuit is in a range of 45° to 135°.

In some embodiments, the bone conduction vibrator and the air conduction vibrator are located in a same housing. A vibration of the bone conduction vibrator is transmitted to a face-attaching side of the housing. The air conduction vibrator emits sounds through two sound guiding holes on a front side and a rear side of the diaphragm, respectively. One of the two sound guiding holes faces an opening of an ear canal.

In some embodiments, each of the two sound guiding holes is provided with a waterproof breathable membrane.

In some embodiments, the earphone includes an ear hook configured to position the housing at a front side of a tragus.

One or more embodiments of the present disclosure further provide a method for controlling an earphone. The earphone includes an air conduction vibrator configured to generate an air conduction sound, a bone conduction vibrator configured to generate a bone conduction sound, and a control circuit. The method comprises: receiving a control signal by the control circuit; and performing, by the control circuit and in response to the control signal, switching from a first working state of the earphone to a second working state of the earphone. The first working state or the second working state includes a working state in which the bone conduction vibrator operates alone or a working state in which the air conduction vibrator operates alone.

In some embodiments, the earphone is provided with a control key, and the control signal originates from an instruction generated by a user operating the control key.

In some embodiments, the earphone is provided with at least one sensor for detecting at least one environmental parameter, and the control signal originates from a numerical change of the environmental parameter satisfying a preset condition.

In some embodiments, the environmental parameter includes a liquid weight at a specific position on the earphone; and the preset condition is that the liquid weight exceeds a first threshold, or the preset condition is that the liquid weight is less than a third threshold.

In some embodiments, the environmental parameter includes a volume of environmental noise; and the preset condition is that the volume of the environmental noise exceeds a second threshold, or the preset condition is that the volume of the environmental noise is less than a fourth threshold.

In some embodiments, the first working state or the second working state includes a working state in which the air conduction vibrator and the bone conduction vibrator operate simultaneously.

### BRIEF DESCRIPTION OF THE DRAWINGS

The present disclosure is further illustrated in terms of exemplary embodiments. These exemplary embodiments are described in detail with reference to the drawings. These embodiments are not limiting. In these embodiments, the same reference numerals denote the same structures, wherein:

FIG. 1 is a schematic diagram illustrating an exemplary application scenario of an earphone according to some embodiments of the present disclosure;

FIG. 2 is a schematic diagram illustrating an exemplary framework structure of an earphone according to some embodiments of the present disclosure;

FIG. 3 is a schematic diagram illustrating an exemplary structure of a bone conduction vibrator according to some embodiments of the present disclosure;

FIG. 4 is a schematic diagram illustrating an exemplary structure of an air conduction vibrator according to some embodiments of the present disclosure;

FIG. 5A is a schematic diagram illustrating a plurality of working states of an earphone and switching modes thereof according to some embodiments of the present disclosure;

FIG. 5B is a flowchart illustrating an exemplary process for state switching of an earphone according to some embodiments of the present disclosure;

FIG. 6 is a schematic diagram illustrating an exemplary structure of an earphone according to some embodiments of the present disclosure; and

FIG. 7 is a schematic diagram illustrating an exemplary earphone in a wearing state according to some embodiments of the present disclosure.

### DETAILED DESCRIPTION

To more clearly illustrate the technical solutions of the embodiments of the present disclosure, the accompanying drawings used in the description of the embodiments will be briefly introduced below. Obviously, the accompanying drawings in the following description are merely some examples or embodiments of the present disclosure. For those skilled in the art, the present disclosure may be applied to other similar scenarios based on these accompanying drawings without creative efforts. Unless obviously obtained from the context or the context illustrates otherwise, the same numeral in the drawings refers to the same structure or operation.

It should be understood that the terms “system”, “device”, “unit”, and/or “module” used herein are methods for distinguishing components, elements, parts, sections, or assemblies of different levels. However, if other words can achieve the same purpose, the words may be replaced by other expressions.

As used in the disclosure and the appended claims, the singular forms “a,” “an,” and “the” include plural referents unless the content clearly dictates otherwise. Generally, the terms “include” and “comprise” only indicate that clearly identified steps and elements are included. These steps and elements do not constitute an exclusive list. A method or device may also include other steps or elements.

In the description of the present disclosure, it should be understood that the terms “first,” “second,” “third,” “fourth,” etc., are used for descriptive purposes only and cannot be understood as indicating or implying relative importance or implicitly indicating the quantity of the indicated technical features. Thus, features defined with “first,” “second,” “third,” and “fourth,” may explicitly or implicitly include at least one of the features. In the description of the present disclosure, the term “a plurality of” means at least two, for example, two or three, unless otherwise explicitly and specifically defined.

In the present disclosure, unless otherwise explicitly specified and defined, terms such as “connect” and “fix” should be understood in a broad sense. For example, the term “connect” may refer to a fixed connection or a detachable connection, or may refer to being integrated into one piece. The connection may be a mechanical connection or an electrical connection. The connection may be a direct connection or an indirect connection through an intermediate medium. The connection may be an internal communication between two elements or an interaction relationship between two elements, unless otherwise explicitly defined. For those skilled in the art, the specific meanings of the above terms in the present disclosure may be understood based on specific situations.

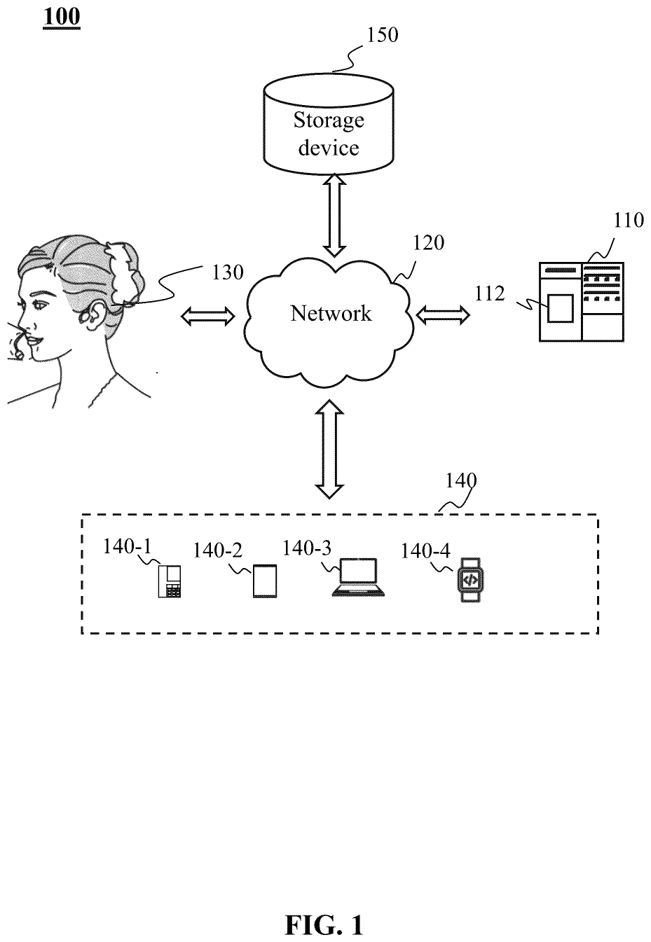

FIG. 1 is a schematic diagram illustrating an exemplary application scenario of an earphone according to some embodiments of the present disclosure. As shown in FIG. 1, in some embodiments, an application scenario 100 of an earphone may include a multimedia platform 110, a network 120, an earphone 130, a user terminal 140, and a storage device 150.

The multimedia platform 110 may communicate with one or more components of the application scenario 100 or an external data source (e.g., a cloud data center). In some embodiments, the multimedia platform 110 may provide data or signals (e.g., audio data of music) to the earphone 130 and/or the user terminal 140. In some embodiments, the multimedia platform 110 may be configured to process data/signals of the earphone 130 and/or the user terminal 140. In some embodiments, the multimedia platform 110 may be implemented on a single server or a server group. The server group may be a centralized server group connected to the network 120 via one or more access points or a distributed server group. In some embodiments, the multimedia platform 110 may be locally connected to the network 120 or remotely connected to the network 120. For example, the multimedia platform 110 may access information and/or data stored in the earphone 130, the user terminal 140, and/or the storage device 150 via the network 120. As another example, the storage device 150 may be used for backend data storage of the multimedia platform 110. In some embodiments, the multimedia platform 110 may be implemented on a cloud platform. Merely by way of example, the cloud platform may include a private cloud, a public cloud, a hybrid cloud, a community cloud, a distributed cloud, an internal cloud, a multi-layer cloud, etc., or any combination thereof.

In some embodiments, the multimedia platform 110 may include a processing device 112. The processing device 112 may perform the main functions of the multimedia platform 110. For example, the processing device 112 may retrieve audio data from the storage device 150 and send the retrieved audio data to the earphone 130 and/or the user terminal 140 to generate sounds. In other embodiments, the processing device 112 may process signals of the earphone 130 (e.g., generate a control signal).

In some embodiments, the processing device 112 may include one or more processing units (e.g., a single-core processing device or a multi-core processing device). Merely by way of example, the processing device 112 may include a central processing unit (CPU), an application-specific integrated circuit (ASIC), an application-specific instruction set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction set computer (RISC), a microprocessor, etc., or any combination thereof.

The network 120 may facilitate information and/or data exchange. In some embodiments, one or more components in the application scenario 100 (e.g., the multimedia platform 110, the earphone 130, the user terminal 140, and the storage device 150) may send information and/or data to other components in the application scenario 100 via the network 120.

The earphone 130 may output sounds to a user and interact with the user. In some embodiments, the earphone 130 may provide audio content to the user, for example, songs, poems, news broadcasts, weather broadcasts, or audio courses. In some embodiments, the user may provide feedback to the earphone 130 through, for example, keys, screen touches, body movements, voice, gestures, or thoughts.

The earphone 130 may communicate with the user terminal 140 via the network 120. In some embodiments, various types of data and/or information may include, but are not limited to, motion parameters (e.g., geographic location, moving direction, moving speed, and acceleration), voice parameters (volume of sound, content of sound, etc.), etc. In some embodiments, the earphone 130 may also send received data and/or information to the multimedia platform 110 or the user terminal 140.

In some embodiments, the earphone 130 may include an air conduction vibrator and a bone conduction vibrator. The air conduction vibrator is configured to generate an air conduction sound. For example, the air conduction vibrator may convert an electrical signal into an air vibration received by a user's ear through a diaphragm. The bone conduction vibrator is configured to generate a bone conduction sound. For example, the bone conduction vibrator may convert an audio signal (e.g., the electrical signal) into a vibration of a housing and transmit the vibration to a user's bone (e.g., a skull). In some embodiments, the earphone 130 may include a plurality of working states, for example, a working state in which the bone conduction vibrator and the air conduction vibrator operate simultaneously, a working state in which the air conduction vibrator operates alone (in this situation, the bone conduction vibrator does not operate), and a working state in which the bone conduction vibrator operates alone (in this situation, the air conduction vibrator does not operate). In some embodiments, the earphone 130 may further include a control circuit. The control circuit is configured to perform a switching operation among the plurality of working states of the earphone 130. In some embodiments, the control circuit performs the switching operation among the plurality of working states of the earphone 130 based on a control signal (e.g., a control signal generated by a user operation or a control signal generated by a change in an environmental parameter detected by a sensor). For example, when the earphone 130 is in a high-noise environment, the control circuit may switch the working state of the earphone 130 from the working state in which the air conduction vibrator operates alone to the working state in which the bone conduction vibrator operates alone. Alternatively, when the earphone 130 is in a relatively quiet environment, the control circuit may switch the working state of the earphone 130 from the working state in which the bone conduction vibrator operates alone to the working state in which the air conduction vibrator operates alone. As another example, when the earphone 130 is in a high-humidity environment or a liquid environment (e.g., the user wears the earphone in scenarios such as rainy days or swimming), the control circuit may switch the working state of the earphone 130 from the working state in which the air conduction vibrator operates alone to the working state in which the bone conduction vibrator operates alone. Alternatively, when the earphone 130 is in a relatively dry environment, the control circuit may switch the working state of the earphone 130 from the working state in which the bone conduction vibrator operates alone to the working state in which the air conduction vibrator operates alone. As another example, when the earphone 130 is in a low battery state, the control circuit may switch the working state of the earphone 130 from the working state in which the bone conduction vibrator and the air conduction vibrator operate simultaneously to the working state in which the bone conduction vibrator operates alone or the working state in which the air conduction vibrator operates alone. As another example, when the earphone 130 is in a call state, the control circuit may switch the working state of the earphone 130 from the working state in which the air conduction vibrator operates alone (or the working state in which the bone conduction vibrator operates alone) to the working state in which the bone conduction vibrator and the air conduction vibrator operate simultaneously.

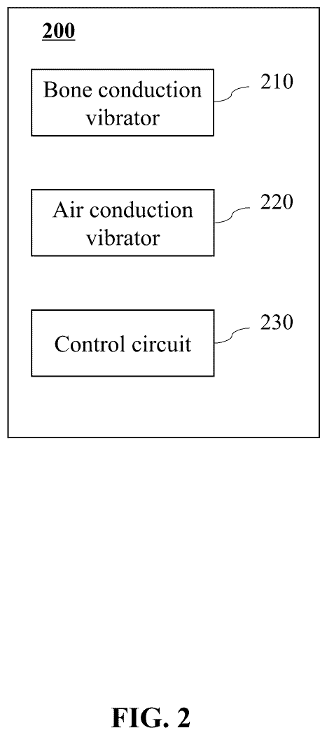

More descriptions regarding the earphone 130 may be found elsewhere in the present disclosure, e.g., FIG. 2 to FIG. 7 and related descriptions thereof.

In some embodiments, the user terminal 140 may be customized. For example, an application may be installed on the user terminal 140, and the application may be configured to communicate with data and/or a signal of the earphone 130 and/or implement processing of the data and/or the signal. The user terminal 140 may include a mobile device 140-1, a tablet computer 140-2, a laptop computer 140-3, a built-in device 140-4 in a vehicle, etc., or any combination thereof. In some embodiments, the mobile device 140-1 may include a smart home device, a smart mobile device, etc., or any combination thereof. In some embodiments, the smart home device may include a smart lighting device, a smart appliance control device, a smart monitoring device, a smart television, a smart camera, an intercom, etc., or any combination thereof. In some embodiments, the smart mobile device may include a smart phone, a personal digital assistant (PDA), a gaming device, a navigation device, etc., or any combination thereof. In some embodiments, the built-in device 140-4 in the vehicle may include a built-in computer, a built-in television, a built-in tablet computer, etc. In some embodiments, the user terminal 140 may include a signal transmitter and a signal receiver configured to communicate with a positioning device (not shown in the figures) for positioning a location of the user and/or the user terminal 140. In some embodiments, the multimedia platform 110 or the storage device 150 may be integrated into the user terminal 140. In this situation, the functions achievable by the multimedia platform 110 described above may be similarly implemented through the user terminal 140.

The storage device 150 may store data and/or instructions. In some embodiments, the storage device 150 may store data obtained from the multimedia platform 110, the earphone 130, and/or the user terminal 140. In some embodiments, the storage device 150 may store data and/or instructions for implementing various functions achievable by the multimedia platform 110, the earphone 130, and/or the user terminal 140.

In some embodiments, the multimedia platform 110, the network 120, the user terminal 140, and/or the storage device 150 may be integrated onto the earphone 130. For example, the earphone 130 may be a smart earphone, an MP3 player, etc., having highly integrated electronic components (e.g., a CPU and a GPU).

It should be noted that the above description of the application scenario 100 is merely for illustration and explanation, and does not limit the applicable scope of the present disclosure. For those skilled in the art, various modifications and changes may be made to the application scenario 100 under the guidance of the present disclosure. However, these modifications and changes still fall within the scope of the present disclosure.

FIG. 2 is a schematic diagram illustrating an exemplary framework structure of an earphone according to some embodiments of the present disclosure. As shown in FIG. 2, an earphone 200 may include a bone conduction vibrator 210, an air conduction vibrator 220, and a control circuit 230.

The bone conduction vibrator 210 is configured to generate a bone conduction sound. The bone conduction sound refers to a sound wave conducted in the form of mechanical vibration through a solid medium (e.g., a bone). In some embodiments, the bone conduction vibrator 210 may generate the bone conduction sound in a specific frequency range (e.g., a low frequency range, a high frequency range, a medium-low frequency range, or a medium-high frequency range). In some embodiments, the low frequency range (also referred to as low frequency) may refer to a frequency range of 20 Hz-150 Hz, the medium-low frequency range (also referred to as medium-low frequency) may refer to a frequency range of 150 Hz-500 Hz, the medium-high frequency range (also referred to as medium-high frequency) may refer to a frequency range of 500 Hz-5 kHz, and the high frequency range (also referred to as high frequency) may refer to a frequency range of 5 kHz-20 kHz. As another example, the low frequency range may refer to a frequency range of 20 Hz-300 Hz, the medium-low frequency range may refer to a frequency range of 100 Hz-1000 Hz, the medium-high frequency range may refer to a frequency range of 1000 Hz-10 kHz, and the high frequency range may refer to a frequency range of 3 kHz-20 kHz. It should be noted that the values of the frequency ranges are for illustrative purposes only and are not limiting. The definitions of the above frequency ranges may vary according to different application scenarios and different classification criteria. For example, in some other application scenarios, the low frequency range may be a frequency range of 20 Hz-80 Hz, the medium-low frequency range may be a frequency range of 80 Hz-160 Hz, the medium-high frequency range may be a frequency range of 1280 Hz-2560 Hz, and the high frequency range may be a frequency range of 2560 Hz-20 kHz. In some embodiments, different frequency ranges may or may not have overlapping frequencies.

In some embodiments, the bone conduction sound generated by the bone conduction vibrator 210 is output externally through a contact surface of a housing (e.g., a housing 240 described later) of the earphone 200 that contacts a user, and a material and thickness of the contact surface of the housing that contacts the user may affect transmission of the bone conduction sound to the user, thereby affecting sound quality. For example, if the material of the contact surface is relatively flexible, the transmission efficiency of the bone conduction sound in the low frequency range is better than the transmission efficiency of the bone conduction sound in the high frequency range. Conversely, if the material of the contact surface is relatively hard, the transmission efficiency of the bone conduction sound in the high frequency range is better than the transmission efficiency of the bone conduction sound in the low frequency range. In some embodiments, to improve comfort when the user wears the earphone 200, the material of the contact surface may be relatively flexible, and in this situation, the low frequency and/or medium-low frequency effects of the bone conduction vibrator 210 are better.

In some embodiments, the bone conduction vibrator 210 may include a first magnetic circuit, a vibration plate, and a first coil. The first magnetic circuit may generate a magnetic field, so that the first coil located in a magnetic gap vibrates under the action of the magnetic field, and the vibration of the first coil may drive the vibration plate to vibrate. The vibration plate is physically connected to the housing of the earphone 200, the housing contacts the skin of the user (e.g., the skin on the head of the user), and transmits the bone conduction sound to the cochlea of the user wearing the earphone 200.

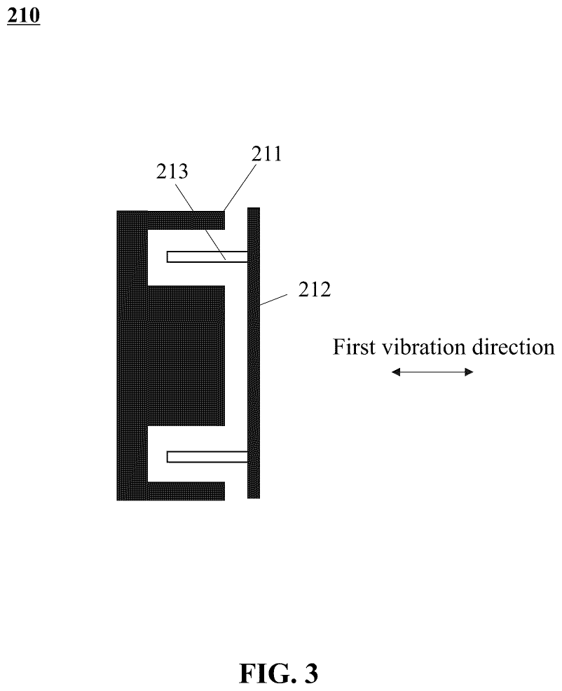

FIG. 3 is a schematic diagram illustrating an exemplary structure of a bone conduction vibrator according to some embodiments of the present disclosure. As shown in FIG. 3, the bone conduction vibrator 210 includes a first magnetic circuit 211, a vibration plate 212, and a first coil 213.

The first magnetic circuit 211 may include one or more magnetic elements and/or magnetic conducting elements configured to generate a magnetic field. In some embodiments, the first magnetic circuit 211 may include a magnetic gap, the first magnetic circuit 211 may generate the magnetic field in the magnetic gap, the first coil 213 is located in the magnetic gap, and the first coil 213 is mechanically connected to the vibration plate 212. In some embodiments, the first coil 213 may be electrically connected to a control circuit (e.g., the control circuit 230 described later). When a current (which may represent a control signal) is introduced into the first coil 213, the first coil 213 may vibrate in the magnetic field and drive the vibration plate 212 to vibrate. A vibration direction of the vibration plate 212 may be a first vibration direction as shown in FIG. 3, i.e., when the first coil 213 vibrates in the magnetic field, the first coil 213 drives the vibration plate 212 to vibrate along the first vibration direction. The vibration of the vibration plate 212 may be transmitted to a bone of the user through the housing of the earphone 200 to generate the bone conduction sound. In some embodiments, the vibration plate 212 may also directly contact the user, and the vibration of the vibration plate 212 is directly transmitted to the bone of the user to generate the bone conduction sound.

The air conduction vibrator 220 is configured to generate an air conduction sound. The air conduction sound refers to a sound wave conducted through an air vibration. In some embodiments, the air conduction vibrator 220 may generate the air conduction sound in a specific frequency range (e.g., a low frequency range, a high frequency range, a medium-low frequency range, or a medium-high frequency range). In some embodiments, the air conduction vibrator 220 has better medium-high frequency and/or high frequency effects compared to the bone conduction vibrator 210. In some embodiments, the air conduction vibrator 220 is configured to generate an air conduction sound having a frequency range that is the same as or different from the vibration of the bone conduction vibrator 210. For example, when the bone conduction vibrator 210 and the air conduction vibrator 220 operate simultaneously, the bone conduction sound generated by the bone conduction vibrator 210 includes more low-frequency components, and the air conduction sound generated by the air conduction vibrator 220 includes more high-frequency components. As another example, when the bone conduction vibrator 210 operates alone (i.e., the bone conduction vibrator 210 operates and the air conduction vibrator 220 does not operate), the bone conduction sound generated by the bone conduction vibrator 210 includes a full frequency band sound. Alternatively, when the air conduction vibrator 220 operates alone (i.e., the air conduction vibrator 220 operates and the bone conduction vibrator 210 does not operate), the air conduction sound generated by the air conduction vibrator 220 includes a full frequency band sound.

In some embodiments, the air conduction vibrator 220 includes a diaphragm, a second magnetic circuit, and a second coil. The second magnetic circuit is configured to generate a magnetic field, such that the second coil located in a magnetic gap vibrates under the action of the magnetic field. The vibration of the second coil is configured to drive the diaphragm to vibrate. The vibration of the diaphragm drives air in the housing (e.g., the housing 240 described later) of the earphone 200 to vibrate. An air vibration in the housing may be transmitted outward to generate the air conduction sound. For example, the air vibration in the housing may be transmitted outward through a sound guiding hole on the housing to generate the air conduction sound.

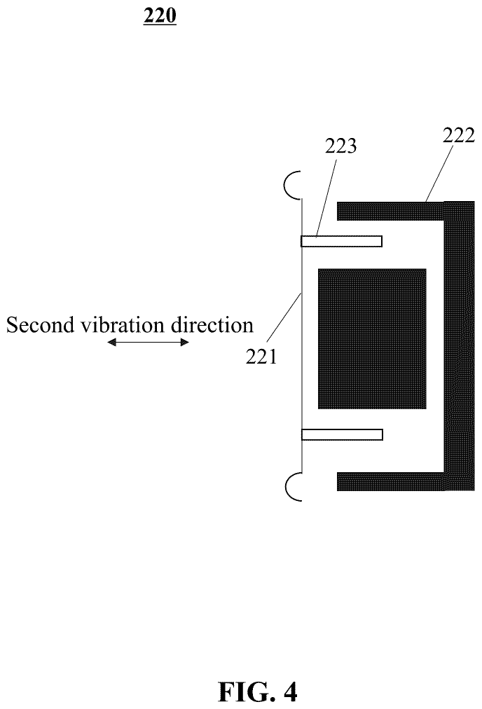

FIG. 4 is a schematic diagram illustrating an exemplary structure of an air conduction vibrator according to some embodiments of the present disclosure. As shown in FIG. 4, the air conduction vibrator 220 includes a diaphragm 221, a second magnetic circuit 222, and a second coil 223.

The second magnetic circuit 222 may include one or more magnetic elements and/or magnetic conducting elements. The second magnetic circuit 222 is configured to generate a magnetic field. In some embodiments, the second magnetic circuit 222 may include a magnetic gap. The second magnetic circuit 222 is configured to generate the magnetic field in the magnetic gap. The second coil 223 is located in the magnetic gap. The second coil 223 is mechanically connected to the diaphragm 221. In some embodiments, the second coil 223 is electrically connected to a control circuit (e.g., the control circuit 230 described later). When a current (which may represent a control signal) is introduced into the second coil 223, the second coil 223 vibrates in the magnetic field and drives the diaphragm 221 to vibrate. A vibration direction of the diaphragm 221 may be a second vibration direction shown in FIG. 4, that is, when the second coil 223 vibrates in the magnetic field, the second coil 223 drives the diaphragm 221 to vibrate along the second vibration direction. The vibration of the diaphragm 221 may cause air in the housing of the earphone 200 to vibrate to generate the air conduction sound. Further, the air conduction sound may be transmitted to an ear canal of the user through the sound guiding hole on the housing.

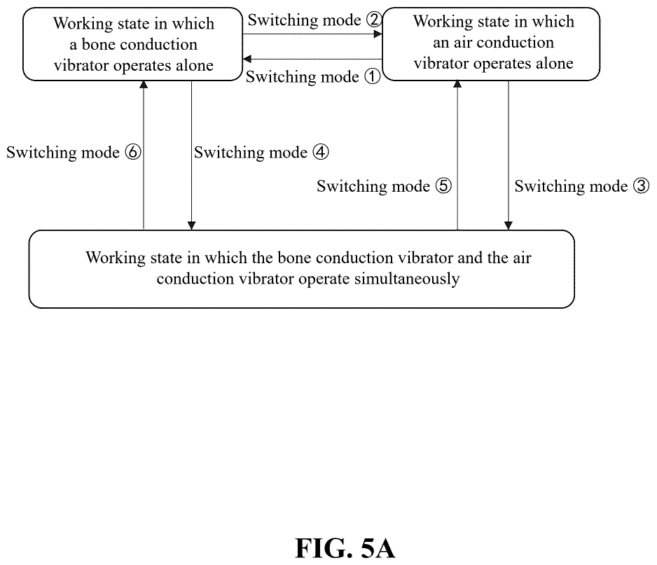

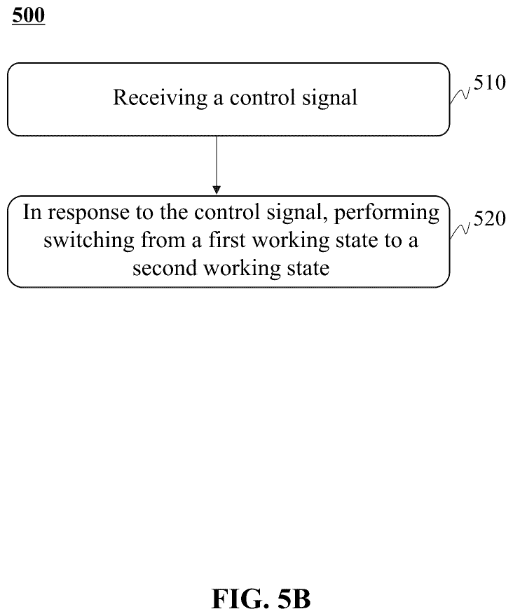

The control circuit 230 is configured to perform a switching operation among a plurality of working states of the earphone 200. FIG. 5A is a schematic diagram illustrating a plurality of working states of an earphone and switching modes thereof according to some embodiments of the present disclosure. As shown in FIG. 5A, in some embodiments, the plurality of working states of the earphone 200 include a working state in which the air conduction vibrator 220 operates alone and a working state in which the bone conduction vibrator 210 operates alone. In some embodiments, the plurality of working states of the earphone 200 further include a working state in which the bone conduction vibrator 210 and the air conduction vibrator 220 operate simultaneously.

In some embodiments, the bone conduction vibrator 210 and the air conduction vibrator 220 are controlled by the control circuit 230, respectively. For example, the control circuit 230 is electrically connected to the bone conduction vibrator 210 (e.g., the first coil 213) to control a working state of the bone conduction vibrator 210. The control circuit 230 is electrically connected to the air conduction vibrator 220 (e.g., the second coil 223) to control a working state of the air conduction vibrator 220. In some embodiments, the control circuit 230 is configured to switch the working state of the earphone 200 from the working state in which the air conduction vibrator 220 operates alone to the working state in which the bone conduction vibrator 210 operates alone (e.g., a switching mode \textcircled{1} shown in FIG. 5A). In some embodiments, the control circuit 230 is configured to switch the working state of the earphone 200 from the working state in which the bone conduction vibrator 210 operates alone to the working state in which the air conduction vibrator 220 operates alone (e.g., a switching mode \textcircled{2} shown in FIG. 5A). In some embodiments, the control circuit 230 is configured to switch the working state of the earphone 200 from the working state in which the air conduction vibrator 220 operates alone to the working state in which the bone conduction vibrator 210 and the air conduction vibrator 220 operate simultaneously (e.g., a switching mode \textcircled{3} shown in FIG. 5A). In some embodiments, the control circuit 230 is configured to switch the working state of the earphone 200 from the working state in which the bone conduction vibrator 210 operates alone to the working state in which the bone conduction vibrator 210 and the air conduction vibrator 220 operate simultaneously (e.g., a switching mode \textcircled{4} shown in FIG. 5A). In some embodiments, the control circuit 230 is configured to switch the working state of the earphone 200 from the working state in which the bone conduction vibrator 210 and the air conduction vibrator 220 operate simultaneously to the working state in which the air conduction vibrator 220 operates alone (e.g., a switching mode \textcircled{5} shown in FIG. 5A). In some embodiments, the control circuit 230 is configured to switch the working state of the earphone 200 from the working state in which the bone conduction vibrator 210 and the air conduction vibrator 220 operate simultaneously to the working state in which the bone conduction vibrator 210 operates alone (e.g., a switching mode \textcircled{6} shown in FIG. 5A).

Taking switching the working state of the earphone 200 from the working state in which the air conduction vibrator 220 operates alone to the working state in which the bone conduction vibrator 210 operates alone as an example, the switching process is exemplarily described as follows. When the earphone 200 is in the working state in which the air conduction vibrator 220 operates alone, the control circuit 230 controls a current to be introduced into the second coil 223 (e.g., a circuit is formed between a power supply and the second coil 223). The second coil 223 vibrates in the magnetic field and drives the diaphragm 221 to vibrate, thereby generating the air conduction sound. At this situation, no current is introduced into the first coil 213 (e.g., an open circuit is formed between the power supply and the first coil 213), and the bone conduction vibrator 210 does not operate. When performing the earphone state switching (i.e., switching the working state of the earphone 200 from the working state in which the air conduction vibrator 220 operates alone to the working state in which the bone conduction vibrator 210 operates alone), the control circuit 230 controls the current (which may represent the control signal) to be introduced into the first coil 213 (e.g., a circuit is formed between the power supply and the first coil 213). The first coil 213 vibrates in the magnetic field and drives the vibration plate 212 to vibrate, thereby generating the bone conduction sound. At this situation, no current is introduced into the second coil 223 (e.g., an open circuit is formed between the power supply and the second coil 223), and the air conduction vibrator 220 does not operate. Therefore, the switching of the working state of the earphone is completed.

Using the control circuit to control the earphone to switch among the plurality of working states enables the earphone to operate in a suitable working state in different scenarios and improves flexibility of using the earphone in the different scenarios, thereby improving a user experience.

In some embodiments, the plurality of working states of the earphone 200 include a first working state and a second working state. FIG. 5B is a flowchart illustrating an exemplary process for state switching of an earphone according to some embodiments of the present disclosure. As shown in FIG. 5B, a process 500 includes: operation 510, receiving a control signal; and operation 520, in response to the control signal, performing switching from the first working state to the second working state. In some embodiments, the process 500 is performed by the control circuit 230.

The control signal refers to a signal that controls the control circuit 230 to perform an earphone state switching operation. In some embodiments, the control signal originates from an instruction generated by a user operation. In some embodiments, the control signal originates from an instruction generated by a change of an environmental parameter detected by a sensor provided on the earphone. More descriptions regarding the source of the control signal may be found elsewhere in the present disclosure.

In some embodiments, the first working state refers to the working state in which the air conduction vibrator 220 operates alone, and the second working state refers to the working state in which the bone conduction vibrator 210 operates alone. At this situation, in response to the control signal, the control circuit 230 performs switching from the working state in which the air conduction vibrator 220 operates alone to the working state in which the bone conduction vibrator 210 operates alone (i.e., performs the switching mode \textcircled{1} shown in FIG. 5A). Detailed descriptions of this part may be found in Embodiment (I) later.

In some embodiments, the first working state refers to the working state in which the bone conduction vibrator 210 operates alone, and the second working state refers to the working state in which the air conduction vibrator 220 operates alone. At this situation, in response to the control signal, the control circuit 230 performs switching from the working state in which the bone conduction vibrator 210 operates alone to the working state in which the air conduction vibrator 220 operates alone (i.e., performs the switching mode \textcircled{2} shown in FIG. 5A). Detailed descriptions of this part may be found in Embodiment (II) later.

In some embodiments, the first working state refers to the working state in which the bone conduction vibrator 210 and the air conduction vibrator 220 operate simultaneously, and the second working state refers to the working state in which the bone conduction vibrator operates alone or the working state in which the air conduction vibrator operates alone. At this situation, in response to the control signal, the control circuit 230 performs switching from the working state in which the bone conduction vibrator 210 and the air conduction vibrator 220 operate simultaneously to the working state in which the bone conduction vibrator operates alone or the working state in which the air conduction vibrator operates alone (i.e., performs the switching mode \textcircled{6} shown in FIG. 5A, or performs the switching mode \textcircled{5} shown in FIG. 5A). Detailed descriptions of this part may be found in Embodiment (III) later.

In some embodiments, the first working state refers to the working state in which the bone conduction vibrator operates alone or the working state in which the air conduction vibrator operates alone, and the second working state refers to the working state in which the bone conduction vibrator 210 and the air conduction vibrator 220 operate simultaneously. At this situation, in response to the control signal, the control circuit 230 performs switching from the working state in which the bone conduction vibrator operates alone or the working state in which the air conduction vibrator operates alone to the working state in which the bone conduction vibrator 210 and the air conduction vibrator 220 operate simultaneously (i.e., performs the switching mode \textcircled{4} shown in FIG. 5A, or performs the switching mode \textcircled{3} shown in FIG. 5A). Detailed descriptions of this part may be found in Embodiment (IV) later.

In some embodiments, the earphone 200 is provided with a control key, and the control signal originates from an instruction generated by the user operating the control key. In some embodiments, the control key is a mechanical key (e.g., a button) provided on the earphone 200. The user generates the control signal by pressing the control key. In some embodiments, the control key is a sensing key provided on the earphone 200. The user touches or taps the sensing key or slides on the sensing key to generate the control signal. In some embodiments, the user may also control switching of the working state of the earphone 200 through a terminal device (e.g., a mobile phone or a computer). Merely by way of example, the terminal device is connected to the earphone 200 via a network, an application is installed in the terminal device, and the user controls switching of the working state of the earphone 200 through the application.

In some embodiments, the user may actively switch the working state of the earphone 200 using the control key according to personal needs or in combination with an actual scenario. For example, when the earphone 200 is in a high-noise environment, external noise may drown out the air conduction sound generated by the air conduction vibrator. At this situation, to ensure a listening volume, the user may operate the control key to generate the control signal, and in response to the control signal, the control circuit 230 performs switching from the working state in which the air conduction vibrator operates alone to the working state in which the bone conduction vibrator operates alone. As another example, to reduce a vibration sensation generated by the earphone 200 (the vibration sensation is mainly generated by the vibration of the vibration plate 212 of the bone conduction vibrator 210) and improve comfort of wearing the earphone 200, the user may operate the control key to generate the control signal, and in response to the control signal, the control circuit 230 performs switching from the working state in which the bone conduction vibrator operates alone to the working state in which the air conduction vibrator operates alone.

By providing the control key on the earphone, the user may actively switch the working state of the earphone using the control key according to actual needs, thereby improving flexibility of use of the earphone.

### Embodiment (I)

In this embodiment, the first working state is the working state in which the air conduction vibrator operates alone, and the second working state is the working state in which the bone conduction vibrator operates alone. The control circuit, in response to a control signal, performs switching from the first working state to the second working state, i.e., performs switching from the working state in which the air conduction vibrator operates alone to the working state in which the bone conduction vibrator operates alone.

In some embodiments, the air conduction sound generated by the air conduction vibrator is output through the sound guiding hole on the housing. When the earphone is in a high-humidity environment (e.g., rainy days or swimming), sound production of the air conduction vibrator may be affected. The bone conduction vibrator transmits the bone conduction sound to the user's cochlea through contact with the user's skin, and sound production of the bone conduction vibrator is not affected in this scenario. Based on this, to ensure that the sound production of the earphone 200 is not affected and to ensure a listening effect of the user, the control circuit may perform switching from the working state in which the air conduction vibrator operates alone to the working state in which the bone conduction vibrator operates alone.

In some embodiments, the air conduction sound generated by the air conduction vibrator is transmitted to the user's ear canal through air vibration. When the earphone is in a high-noise environment (e.g., construction sites such as renovation or road construction, noisy crowds, etc.), the air conduction sound generated by the air conduction vibrator may be drowned out by environmental noise (since the environmental noise is transmitted through air). The bone conduction vibrator transmits the bone conduction sound to the user's cochlea by contacting with the user's skin, and the bone conduction sound generated by the bone conduction vibrator is not affected by the environmental noise in this scenario. Based on this, to ensure the listening volume of the user, the control circuit may perform switching from the working state in which the air conduction vibrator operates alone to the working state in which the bone conduction vibrator operates alone.

In some embodiments, the earphone 200 is provided with at least one sensor for detecting at least one environmental parameter, and the control signal originates from a numerical change of the environmental parameter satisfying a first preset condition.

In some embodiments, the at least one sensor may include one or more types. In some embodiments, the at least one sensor may include, but is not limited to, one or more of a weight sensor, a pressure sensor, a hydraulic pressure sensor, a noise sensor, etc. Different types of sensors are configured to detect different environmental parameters. Merely by way of example, the weight sensor is configured to detect the liquid weight at a specific position on the earphone. As another example, the noise sensor is configured to detect external environmental noise.

The first preset condition may be a condition for determining whether the numerical change of the environmental parameter reaches a condition for earphone state switching (e.g., switching from the working state in which the air conduction vibrator operates alone to the working state in which the bone conduction vibrator operates alone). For example, when the numerical change of the environmental parameter satisfies the first preset condition, it indicates that the environment in which the earphone is located has changed. At this time, the control circuit switches the working state of the earphone based on the control signal.

In some embodiments, the first preset condition may be pre-stored in a storage device.

In some embodiments, the at least one environmental parameter includes the liquid weight at the specific position on the earphone, and the first preset condition is that the liquid weight exceeds a first threshold.

For example, the sensor for detecting the liquid weight at the specific position on the earphone may be a weight sensor, and the weight sensor detects the liquid weight at the specific position on the earphone. The specific position on the earphone may be a position on a specific surface of the earphone. For example, the specific position may be a surface of the earphone facing the top of the user's head in a wearing state. Merely by way of example, in a rainy day scenario, liquid is mainly located on the surface of the earphone facing the top of the user's head, facilitating measurement. The first threshold may refer to an upper limit threshold of the liquid weight. In some embodiments, when the weight sensor detects that the liquid weight exceeds the first threshold (i.e., the numerical change of the environmental parameter satisfies the first preset condition), it indicates that the earphone is in a state of being soaked or contaminated by liquid (e.g., rainy days, heavy sweating caused by exercise, or water activities). At this situation, to ensure that the sound production of the earphone is not affected and to ensure the listening effect of the user, the control circuit may perform switching from the working state in which the air conduction vibrator operates alone to the working state in which the bone conduction vibrator operates alone.

In some embodiments, when the first threshold is the upper limit threshold of the liquid weight, the first threshold may be reasonably set according to actual conditions. In some embodiments, to improve accuracy of determining changes of the environmental parameter and more accurately determine changes in the environment in which the earphone is located, the first threshold may be set to a relatively small value. In some embodiments, in certain scenarios (e.g., light sweating caused by exercise or drizzle), the impact of liquid on the sound production of the air conduction vibrator may also be disregarded. At this situation, the first threshold may also be set to a relatively large value.

In some embodiments, the sensor may also be a hydraulic pressure sensor, and the hydraulic pressure sensor detects a liquid pressure at the specific position on the earphone. At this situation, the first threshold refers to an upper limit threshold of the liquid pressure. In some embodiments, when the hydraulic pressure sensor detects that the liquid pressure exceeds the first threshold (i.e., the numerical change of the environmental parameter satisfies the first preset condition), it indicates that the earphone is in the state of being soaked or contaminated by liquid (e.g., swimming or rainy days). At this situation, to ensure that the sound production of the earphone is not affected and to ensure the listening effect of the user, the control circuit may perform switching from the working state in which the air conduction vibrator operates alone to the working state in which the bone conduction vibrator operates alone.

In some embodiments, when the first threshold is the upper limit threshold of the liquid pressure, the first threshold may be not less than 1.013×10⁵ Pa. Merely by way of example, the first threshold may be 1.013×10⁵ Pa. In some embodiments, considering a depth at which the earphone is immersed in liquid (e.g., when immersed to a water depth of 10 mm), the first threshold may be 1.013×10⁵ Pa+98 Pa. In some embodiments, considering the depth at which the earphone is immersed in liquid (e.g., when immersed to a water depth of 100 mm), the first threshold may be 1.013×10⁵ Pa+980 Pa. Merely by way of example for scenario illustration, the above first threshold may be used in swimming scenarios. In some embodiments, to improve the accuracy of determining changes in the environmental parameter and more accurately determine changes in the environment in which the earphone is located, the first threshold may be set to a relatively small value. In some embodiments, in certain scenarios (e.g., light sweating caused by exercise or drizzle), the impact of liquid on the sound production of the air conduction vibrator may also be disregarded. At this situation, the first threshold may also be set to a relatively large value.

In some embodiments, the sensor (e.g., a liquid sensor and a capacitive sensor) may also be disposed in a sound transmission path of the air conduction vibrator or on the diaphragm of the air conduction vibrator. The sensor detects whether liquid has infiltrated the air conduction vibrator. When the sensor detects liquid, the control circuit may perform switching from the working state in which the air conduction vibrator operates alone to the working state in which the bone conduction vibrator operates alone. In some embodiments, the sensor may include a liquid sensor, and the liquid sensor is disposed in the sound transmission path of the air conduction vibrator. When liquid infiltrates, the liquid sensor detects the liquid, and the control circuit performs switching from the working state in which the air conduction vibrator operates alone to the working state in which the bone conduction vibrator operates alone. In some embodiments, the sensor may include a capacitive sensor, and the capacitive sensor is disposed on the diaphragm of the air conduction vibrator (e.g., attached to a surface of the diaphragm). When liquid infiltrates the surface of the diaphragm, a capacitance value of the capacitive sensor changes, and the control circuit performs switching from the working state in which the air conduction vibrator operates alone to the working state in which the bone conduction vibrator operates alone.

By providing the sensor on the earphone to detect the liquid weight (or liquid pressure) at the specific position on the earphone and reasonably setting the first threshold, when the earphone is in the state of being soaked or contaminated by liquid (e.g., rainy days, heavy sweating caused by exercise, or water activities), the control circuit may perform switching from the working state in which the air conduction vibrator operates alone to the working state in which the bone conduction vibrator operates alone, thereby ensuring that the sound production of the earphone is not affected and ensuring the listening effect of the user.

In some embodiments, the environmental parameter may include a volume of the environmental noise, and the first preset condition is that the volume of the environmental noise exceeds a second threshold.

In some embodiments, the sensor for detecting the volume of the environmental noise may be a noise sensor, e.g., a microphone. The microphone is configured to detect the volume of the environmental noise. In some embodiments, the microphone for detecting the environmental noise and the microphone in the earphone for collecting the user's voice may be the same microphone. In some embodiments, a plurality of microphones may also be provided in the earphone, e.g., two microphones, one of which is configured to detect the environmental noise and the other is configured to collect a voice signal of the user. The second threshold may refer to an upper limit threshold of the volume of the environmental noise. In some embodiments, when the noise sensor detects that the volume of the environmental noise exceeds the second threshold (i.e., the numerical change of the environmental parameter satisfies the first preset condition), it indicates that the earphone is in a high-noise environment (e.g., a construction site or a noisy crowd environment). In this situation, to ensure the listening effect of a user, the control circuit may perform switching from the working state in which the air conduction vibrator operates alone to the working state in which the bone conduction vibrator operates alone (or the working state in which the bone conduction vibrator and the air conduction vibrator operate simultaneously).

In some embodiments, the second threshold may be in a range of 60 dB to 90 dB. Merely by way of example, the second threshold is 85 dB. In some embodiments, to improve the listening experience of the user (e.g., a user with weak hearing), the second threshold may be set to a relatively small value.

By setting the sensor on the earphone to detect the volume of the environmental noise and reasonably setting the second threshold, when the earphone is in the high-noise environment, the control circuit may perform switching from the working state in which the air conduction vibrator operates alone to the working state in which the bone conduction vibrator operates alone, thereby ensuring the listening effect of the user.

It may be understood that when the earphone is in the working state in which the bone conduction vibrator operates alone, and the numerical change of the environmental parameter satisfies the first preset condition (the liquid weight exceeds the first threshold, or the volume of the environmental noise exceeds the second threshold), the earphone does not perform a switching operation, i.e., the earphone maintains the working state in which the bone conduction vibrator operates alone.

In some embodiments, the control signal may also originate from the numerical change of the environmental parameter satisfying a time threshold. The time threshold refers to a preset time range. For example, the time threshold may be 5 seconds, 30 seconds, 1 minute, 3 minutes, 5 minutes, 10 minutes, etc. In this situation, the control signal originates from the numerical change of the environmental parameter continuously satisfying the first preset condition within the time threshold. Merely by way of example, when the noise sensor detects that the volume of the environmental noise continuously exceeds the second threshold within the time threshold (e.g., 3 minutes) (i.e., the numerical change of the environmental parameter satisfies the first preset condition), it indicates that the earphone is in a high-noise environment (e.g., a construction site or a noisy crowd environment) for a long time. In this situation, to ensure the listening effect of the user, the control circuit may perform switching from the working state in which the air conduction vibrator operates alone to the working state in which the bone conduction vibrator operates alone. By setting the time threshold, repeated state switching of the earphone can be avoided. For example, in a low-noise scenario (where the influence of noise on the air conduction sound does not need to be considered) in which the earphone is located, a high-noise sound (e.g., a scream) occasionally occurs. Since the high-noise sound occurs occasionally and lasts for a short time, in this situation, the earphone does not need to perform state switching.

In some embodiments of the present disclosure, according to the numerical change of the environmental parameter detected by the sensor, the control circuit automatically performs switching of the working state of the earphone, which has higher intelligence and can improve the use experience.

### Embodiment (II)

In this embodiment, the first working state is the working state in which the bone conduction vibrator operates alone, and the second working state is the working state in which the air conduction vibrator operates alone. The control circuit, in response to a control signal, performs switching from the first working state to the second working state, i.e., performs switching from the working state in which the bone conduction vibrator operates alone to the working state in which the air conduction vibrator operates alone.

In some embodiments, the bone conduction sound generated by the bone conduction vibrator is transmitted to the cochlea of the user in a form of vibration (e.g., a skull vibration). During the transmission of the vibration, a relatively strong vibration sensation may be brought, even causing discomfort. The air conduction sound generated by the air conduction vibrator is transmitted to the ear canal of the user through the air vibration, and does not bring an obvious vibration sensation. Based on this, when the earphone is in a relatively dry environment (i.e., the influence of liquid on the sound production of the air conduction vibrator does not need to be considered), or the earphone is in a low-noise environment (i.e., the influence of environmental noise on the air conduction sound generated by the air conduction vibrator does not need to be considered), to reduce the vibration sensation brought to the user by the vibration of the earphone (especially the bone conduction vibrator) and improve the listening experience, the control circuit may perform switching of the earphone from the working state in which the bone conduction vibrator operates alone to the working state in which the air conduction vibrator operates alone.

In some embodiments, the control signal may originate from the numerical change of the environmental parameter satisfying a second preset condition.

The second preset condition may be a condition for measuring whether the numerical change of the environmental parameter reaches a condition for earphone state switching (switching from the working state in which the bone conduction vibrator operates alone to the working state in which the air conduction vibrator operates alone). For example, when the numerical change of the environmental parameter satisfies the second preset condition, it indicates that an environment in which the earphone is located changes. In this situation, the control circuit performs switching of the working state of the earphone based on the control signal.

In some embodiments, the second preset condition may be pre-stored in the storage device.

In some embodiments, the environmental parameter may include the liquid weight at the specific position on the earphone, and the second preset condition is that the liquid weight is less than a third threshold.

Merely by way of example, the sensor for detecting the liquid weight at the specific position on the earphone may be a weight sensor. The third threshold may refer to a lower limit threshold of the liquid weight. In some embodiments, when the weight sensor detects that the liquid weight is less than the third threshold (i.e., the numerical change of the environmental parameter satisfies the second preset condition), it indicates that the earphone is in a relatively dry environment, and there is no liquid or very little liquid on the earphone, which basically does not affect the sound production of the air conduction vibrator. In this situation, to reduce the vibration sensation brought to the user by the vibration of the earphone (especially the bone conduction vibrator) and improve the listening experience, the control circuit may perform switching of the earphone from the working state in which the bone conduction vibrator operates alone to the working state in which the air conduction vibrator operates alone.

In some embodiments, when the third threshold is the lower limit threshold of the liquid weight, the third threshold may be reasonably set according to actual situations. In some embodiments, a small amount of liquid may also affect the sound production of the air conduction vibrator. To avoid abnormal sound production of the earphone, the third threshold may be set to a relatively large value.

In some embodiments, the sensor may also be a hydraulic pressure sensor, and the hydraulic pressure sensor detects a liquid pressure at the specific position on the earphone. The third threshold refers to a lower limit threshold of the liquid pressure. In some embodiments, when the hydraulic pressure sensor detects that the liquid pressure is less than the third threshold (i.e., the numerical change of the environmental parameter satisfies the second preset condition), it indicates that the earphone is in the relatively dry environment, and there is no liquid or very little liquid on the earphone, which basically does not affect the sound production of the air conduction vibrator. In this situation, to reduce the vibration sensation brought to the user by the vibration of the earphone (especially the bone conduction vibrator) and improve the listening experience, the control circuit may perform switching of the earphone from the working state in which the bone conduction vibrator operates alone to the working state in which the air conduction vibrator operates alone.

In some embodiments, when the third threshold is the lower limit threshold of the liquid pressure, the third threshold may be less than 1.013×10⁵ Pa. In some embodiments, a small amount of liquid may also affect the sound production of the air conduction vibrator. To avoid abnormal sound production of the earphone, the third threshold may be set to a relatively large value.

By setting the sensor on the earphone to detect the liquid weight (or the liquid pressure) at the specific position on the earphone and reasonably setting the third threshold, when the earphone is in the relatively dry environment, the control circuit may perform switching of the earphone from the working state in which the bone conduction vibrator operates alone to the working state in which the air conduction vibrator operates alone, thereby reducing the vibration sensation brought to the user by the vibration of the earphone (especially the bone conduction vibrator) and improving the listening experience.

In some embodiments, the environmental parameter may include the volume of the environmental noise, and the second preset condition is that the volume of the environmental noise is less than a fourth threshold.

The fourth threshold may refer to a lower limit threshold of the volume of the environmental noise. In some embodiments, when the noise sensor detects that the volume of the environmental noise is less than the fourth threshold (i.e., the numerical change of the environmental parameter satisfies the second preset condition), it indicates that the earphone is in a low-noise environment, and the influence of the environmental noise on the air conduction sound generated by the air conduction vibrator is small or negligible. In this situation, to reduce the vibration sensation brought to the user by the vibration of the earphone (especially the bone conduction vibrator) and improve the listening experience, the control circuit may perform switching of the earphone from the working state in which the bone conduction vibrator operates alone to the working state in which the air conduction vibrator operates alone.

In some embodiments, the fourth threshold may be less than 50 dB. In some embodiments, small environmental noise may also affect the air conduction sound generated by the air conduction vibrator to some extent, and the listening effect of a population with poor hearing may be affected. Therefore, to meet the listening needs of the population with poor hearing, the fourth threshold may be set to a relatively large value.

By setting the sensor on the earphone to detect the volume of the environmental noise and reasonably setting the fourth threshold, when the earphone is in the low-noise environment, the control circuit may perform switching of the earphone from the working state in which the bone conduction vibrator operates alone to the working state in which the air conduction vibrator operates alone, thereby reducing the vibration sensation brought to the user by the vibration of the earphone (especially the bone conduction vibrator) and improving the listening experience.

It may be understood that when the earphone is in the working state in which the air conduction vibrator operates alone, and the numerical change of the environmental parameter satisfies the second preset condition (the liquid weight is less than the third threshold, or the volume of the environmental noise is less than the fourth threshold), the earphone does not perform a switching operation, i.e., the earphone maintains the working state in which the air conduction vibrator operates alone.

In some embodiments, the control signal may also originate from the numerical change of the environmental parameter satisfying a time threshold. The time threshold refers to a preset time range. For example, the time threshold may be 5 seconds, 30 seconds, 1 minute, 3 minutes, 5 minutes, 10 minutes, etc. In this situation, the control signal originates from the numerical change of the environmental parameter continuously satisfying the second preset condition within the time threshold. Merely by way of example, when the noise sensor detects that the volume of the environmental noise is less than the fourth threshold within the time threshold (e.g., 3 minutes) (i.e., the numerical change of the environmental parameter satisfies the second preset condition), it indicates that the earphone is in a low-noise environment for a long time. At this situation, to reduce the vibration sensation caused by the vibration of the earphone (especially the bone conduction vibrator) to the user and improve the listening experience, the control circuit may perform switching from the working state in which the bone conduction vibrator operates alone to the working state in which the air conduction vibrator operates alone. By setting the time threshold, repeated state switching of the earphone can be avoided.

In some embodiments, the control circuit may also perform switching from the working state in which the bone conduction vibrator operates alone to the working state in which the air conduction vibrator operates alone based on a power level of the earphone. For example, when the power level of the earphone is lower than a power threshold (e.g., 10% or 20%), to reduce power consumption and extend the usage time, the control circuit performs switching from the working state in which the bone conduction vibrator operates alone to the working state in which the air conduction vibrator operates alone.

### Embodiment (III)

In this embodiment, the first working state is the working state in which the bone conduction vibrator and the air conduction vibrator operate simultaneously, and the second working state is the working state in which the bone conduction vibrator operates alone or the working state in which the air conduction vibrator operates alone. The control circuit performs switching from the first working state to the second working state in response to a control signal, i.e., performs switching from the working state in which the bone conduction vibrator and the air conduction vibrator operate simultaneously to the working state in which the bone conduction vibrator operates alone or the working state in which the air conduction vibrator operates alone.

In some embodiments, the control circuit may perform switching from the working state in which the bone conduction vibrator and the air conduction vibrator operate simultaneously to the working state in which the bone conduction vibrator operates alone. For example, when the earphone is in a high-humidity environment, to prevent liquid from affecting sound generation of the air conduction vibrator, the control circuit may perform switching from the working state in which the bone conduction vibrator and the air conduction vibrator operate simultaneously to the working state in which the bone conduction vibrator operates alone.

In some embodiments, the control circuit may perform switching from the working state in which the bone conduction vibrator and the air conduction vibrator operate simultaneously to the working state in which the air conduction vibrator operates alone. For example, to reduce a vibration sensation caused by the vibration of the earphone (especially the bone conduction vibrator) to the user and improve the listening experience, the control circuit may perform switching from the working state in which the bone conduction vibrator and the air conduction vibrator operate simultaneously to the working state in which the air conduction vibrator operates alone.

In some embodiments, the control circuit may also perform switching from the working state in which the bone conduction vibrator and the air conduction vibrator operate simultaneously to the working state in which the air conduction vibrator operates alone or the working state in which the bone conduction vibrator operates alone based on the power level of the earphone. For example, when the power level of the earphone is lower than a power threshold (e.g., 10% or 20%), to reduce power consumption and extend the usage time, the control circuit performs switching from the working state in which the bone conduction vibrator and the air conduction vibrator operate simultaneously to the working state in which the air conduction vibrator operates alone or the working state in which the bone conduction vibrator operates alone.

### Embodiment (IV)

In this embodiment, the first working state is the working state in which the bone conduction vibrator operates alone or the working state in which the air conduction vibrator operates alone, and the second working state is the working state in which the bone conduction vibrator and the air conduction vibrator operate simultaneously. The control circuit performs switching from the first working state to the second working state in response to a control signal, i.e., performs switching from the working state in which the bone conduction vibrator operates alone or the working state in which the air conduction vibrator operates alone to the working state in which the bone conduction vibrator and the air conduction vibrator operate simultaneously.

In some embodiments, as described in FIG. 3 and FIG. 4, the bone conduction vibrator has a better low frequency (or medium-low frequency) effect, and the air conduction vibrator has a better high frequency (or medium-high frequency) effect. For example, the bone conduction vibrator has a better voice output effect in a frequency range of 50 Hz-500 Hz, and the air conduction vibrator has a better voice output effect in a range greater than 1000 Hz-3000 Hz. Switching the working state of the earphone to the working state in which the bone conduction vibrator and the air conduction vibrator operate simultaneously may allow a low frequency sound of the bone conduction vibrator and a high frequency sound of the air conduction vibrator to complement each other, thereby improving an acoustic performance of the earphone.

In some embodiments, a frequency response corresponding to a single oscillator (the bone conduction vibrator or the air conduction vibrator) operating alone may be different from a frequency response corresponding to the single oscillator when the two oscillators operate simultaneously. For example, when the bone conduction vibrator operates alone, to achieve a sound output effect of the earphone in a relatively large frequency range, the frequency response of the bone conduction vibrator covers a relatively wide frequency range (e.g., a range from low-frequency to high-frequency). When the bone conduction vibrator and the air conduction vibrator operate simultaneously, to reduce a low-frequency vibration sensation of the bone conduction vibrator, the frequency response of the bone conduction vibrator may mainly cover a medium-high frequency range. In some embodiments, adjustment of a frequency response curve of an oscillator (the bone conduction vibrator or the air conduction vibrator) may be implemented by a filter. For example, by controlling a connection state (e.g., connected or disconnected) between the oscillator and the filter, adjustment of the frequency response curve of the oscillator is implemented. In some embodiments, a test manner for the frequency response curve of the oscillator may be: providing an initial signal (a signal before filtering) to the oscillator, and obtaining a frequency spectrum characteristic of the oscillator by analyzing a sound output of the oscillator.

It should be noted that the working state switching described in the embodiments of the present disclosure under different scenarios is merely exemplary. In other embodiments, other optional switching modes may also be performed under the same scenarios, and any other feasible switching modes fall within the protection scope of the present disclosure. For example, in a high-noise scenario, to ensure the listening volume, the control circuit may also perform switching from the working state in which the air conduction vibrator operates alone to the working state in which the bone conduction vibrator and the air conduction vibrator operate simultaneously.

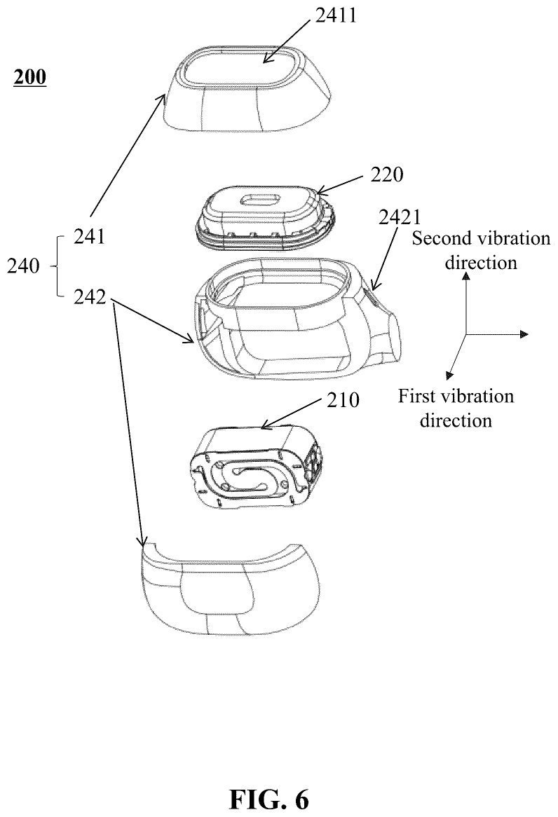

FIG. 6 is a schematic diagram illustrating an exemplary structure of an earphone according to some embodiments of the present disclosure. As shown in FIG. 6, the earphone 200 includes the housing 240, and the bone conduction vibrator 210 and the air conduction vibrator 220 are located in the housing 240.

In some embodiments, the housing 240 may include a first portion 241 and a second portion 242. The first portion 241 and the second portion 242 are fastened to form a hollow frame body. The bone conduction vibrator 210 and the air conduction vibrator 220 are located in a hollow portion inside the housing 240. In some embodiments, the first portion 241 and a diaphragm of the air conduction vibrator 220 may form a first chamber, and an air conduction sound wave generated by the air conduction vibrator 220 may be transmitted from the first chamber to an exterior of the earphone 200. The second portion 242 and the diaphragm of the air conduction vibrator 220 form a second chamber. The bone conduction vibrator 210 is located in the second chamber.

In some embodiments, a vibration plate of the bone conduction vibrator 210 is physically connected to a face-attaching side on the housing 240 (the second portion 242), and a bone conduction sound generated by the bone conduction vibrator 210 is transmitted to a bone of a user through the face-attaching side of the housing 240, thereby transmitting the bone conduction sound to a cochlea of the user wearing the earphone 200. In some embodiments, the face-attaching side on the housing 240 may refer to a side surface of the housing 240 that is in contact with the face of the user in a wearing state.

In some embodiments, a front side and a rear side of the diaphragm of the air conduction vibrator 220 are respectively provided with sound guiding holes, and the air conduction vibrator 220 generates sounds through the two sound guiding holes on the front side and the rear side of the diaphragm. One of the sound guiding holes is directed toward an opening of an ear canal. In some embodiments, the front side of the diaphragm refers to a side of the diaphragm facing away from the second magnetic circuit. As shown in FIG. 4, the front side of the diaphragm 221 refers to a side of the diaphragm 221 facing away from the second magnetic circuit 222. The rear side of the diaphragm refers to a side of the diaphragm facing toward the second magnetic circuit. As shown in FIG. 4, the rear side of the diaphragm 221 refers to a side of the diaphragm 221 facing toward the second magnetic circuit 222.

In some embodiments, as shown in FIG. 6, a sound guiding hole 2411 may be provided on the rear side of the diaphragm of the air conduction vibrator 220, and when the earphone 200 is in the wearing state, the sound guiding hole 2411 faces toward the opening of the ear canal. The sound guiding hole 2411 is acoustically connected to the first chamber. The sound guiding hole 2411 is configured to transmit an air conduction sound in the first chamber to the exterior of the earphone 200 (e.g., to the opening of the ear canal of the user).

In some embodiments, as shown in FIG. 6, a sound guiding hole 2421 may be provided on the front side of the diaphragm of the air conduction vibrator 220. The sound guiding hole 2421 is acoustically connected to the second chamber. The sound guiding hole 2421 is configured to transmit an air conduction sound in the second chamber to the exterior of the earphone 200. In some embodiments, the sound guiding hole 2421 may be a through hole, and the through hole may facilitate pressure balance between the second chamber of the housing 240 and the exterior of the earphone 200.

In some embodiments, each of the sound guiding hole 2411 and the sound guiding hole 2421 may be respectively provided with a waterproof breathable membrane. The waterproof breathable membrane may separate an interior of the chamber (the first chamber and the second chamber) from the exterior of the earphone to a certain extent, and may prevent external liquid from entering the sound guiding holes while not hindering transmission of the air conduction sound through the sound guiding holes, thereby avoiding an effect of the liquid on sound generation of the air conduction vibrator 220. By providing the waterproof breathable membrane at the sound guiding holes, waterproof and dustproof performance of the earphone can be improved.

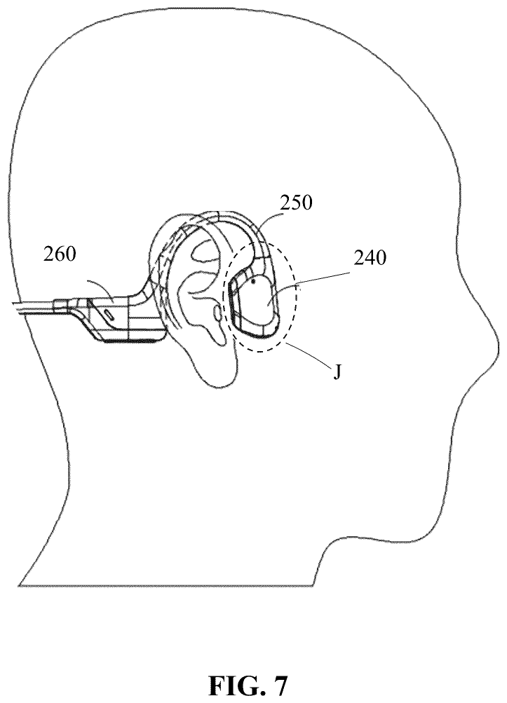

FIG. 7 is a schematic diagram illustrating an exemplary earphone in a wearing state according to some embodiments of the present disclosure.

In some embodiments, as shown in FIG. 7, the earphone 200 may include an ear hook 250 configured to position the housing 240 at a front side of a tragus. The front side of the tragus may be a dashed region J shown in FIG. 7. By using the ear hook 250 to position the housing 240 at the front side of the tragus, on one hand, one sound guiding hole of the earphone (e.g., the sound guiding hole 2411 in FIG. 6) may be directed toward the opening of the ear canal, facilitating the transmission of the air conduction sound guided through the sound guiding hole to the opening of the ear canal. On the other hand, the face-attaching side of the housing may better fit the face, improving the transmission effect of the bone conduction sound.

In some embodiments, the ear hook 250 may include an elastic support member. When the user wears the earphone 200, the elastic support member may be configured to hook the earphone 200 at the ear, with the housing 240 located at the front side of the tragus. The elastic support member may be configured to maintain the ear hook 250 in a shape matching the user's ear, so that the ear hook 250 may undergo an elastic deformation adapted to the ear and head shapes of the user. When the user wears the earphone 200, the elastic support member may adapt to users with different ear shapes and head shapes. In some embodiments, the elastic support member may be made of a shape memory alloy with good deformation recovery capability. The shape memory alloy refers to a material composed of two or more metallic elements that exhibit a shape memory effect through thermoelastic martensitic transformation and its inverse transformation. In some embodiments, the shape memory alloy may include, but is not limited to, a nickel-titanium alloy, a copper-zinc alloy, an iron-manganese alloy, a nickel-aluminum alloy, a gold-cadmium alloy, or any combination thereof. In some embodiments, the elastic support member may also be a support member made of other materials (e.g., an organic polymer material). In some embodiments, the organic polymer material may include rubber, chemical fibers, plastic, or any combination thereof. In some embodiments, the elastic support member may also be made of a non-shape memory alloy. In some embodiments, a wire in the elastic support member may establish an electrical connection between sound-producing oscillators (e.g., the bone conduction vibrator and the air conduction vibrator) and other components (e.g., a functional assembly 260), to facilitate charging and data transmission of the sound-producing oscillators.

In some embodiments, the earphone 200 may further include the functional assembly 260. The housing 240 and the functional assembly 260 may be disposed at two ends of the ear hook 250, respectively, to maintain balance. The functional assembly 260 is electrically connected to a sound-producing assembly (e.g., the bone conduction vibrator and the air conduction vibrator). The functional assembly 260 may control sound production of the sound-producing assembly. In some embodiments, the functional assembly 260 may include a functional housing, a circuit board (e.g., the control circuit 230), and/or a battery. In some embodiments, the functional housing may be connected to the other end of the ear hook 250 (one end away from the sound-producing assembly). The functional housing of the functional assembly 260 is physically connected to the housing 240 via the ear hook 250. An accommodation space may be formed inside the functional housing for accommodating the circuit board and/or the battery. In some embodiments, the circuit board (e.g., the control circuit 230) may control the sound production of the bone conduction vibrator and the air conduction vibrator. In some embodiments, the functional assembly 260 may provide electrical energy for the earphone 200. For example, the battery in the functional assembly 260 may be electrically connected to the sound-producing assembly, so that the battery can provide electrical energy for sound production of the bone conduction vibrator and the air conduction vibrator. In some embodiments, the circuit board and the battery may be disposed in a same housing (e.g., both are disposed in the functional housing). In some embodiments, the circuit board and the battery may be disposed in two housings, respectively (e.g., disposed in the functional housing and the housing 240, respectively). The circuit board and the battery may be electrically connected to each other via conductors, and further electrically connected to the sound-producing assembly via the conductors.

In some embodiments, to reduce mutual interference during sound production of the two oscillators, an angle between the first vibration direction of the vibration plate of the bone conduction vibrator 210 in the first magnetic circuit and the second vibration direction of the diaphragm of the air conduction vibrator 220 in the second magnetic circuit may in a range of 45° to 135°. In some embodiments, the angle may in a range of 60° to 120°. In some embodiments, the angle may in a range of 70° to 110°. In some embodiments, the angle may in a range of 80° to 100°.

In some embodiments, as shown in FIG. 6, the first vibration direction and the second vibration direction may be set to be perpendicular to each other, to further reduce mutual interference during sound production of the two oscillators.

The basic concepts have been described above. Obviously, to those skilled in the art, the above detailed disclosure is merely an example and does not constitute a limitation to the present disclosure. Although not explicitly stated here, those skilled in the art may make various modifications, improvements, and amendments to the present disclosure. These alterations, improvements, and modifications are intended to be suggested by the present disclosure, and are within the spirit and scope of the exemplary embodiments of the present disclosure.

1. An earphone, comprising:
an air conduction vibrator configured to generate an air conduction sound;
a bone conduction vibrator configured to generate a bone conduction sound; and
a control circuit configured to perform a switching operation among a plurality of working states of the earphone, wherein the plurality of working states of the earphone include at least one of a working state in which the air conduction vibrator operates alone and a working state in which the bone conduction vibrator operates alone.

2. The earphone of claim 1, wherein the plurality of working states of the earphone include a first working state and a second working state, and the control circuit is configured to:
receive a control signal; and
perform switching from the first working state to the second working state in response to the control signal.

3. The earphone of claim 2, wherein the earphone is provided with a control key, and the control signal originates from an instruction generated by a user operating the control key.

4. The earphone of claim 2, wherein the first working state is the working state in which the air conduction vibrator operates alone, and the second working state is the working state in which the bone conduction vibrator operates alone.

5. The earphone of claim 4, wherein the earphone is provided with at least one sensor for detecting at least one environmental parameter, and the control signal originates from a numerical change of the environmental parameter satisfying a first preset condition.

6. The earphone of claim 5, wherein the environmental parameter includes a liquid weight at a specific position on the earphone, and the first preset condition is that the liquid weight exceeds a first threshold.

7. The earphone of claim 5, wherein the environmental parameter includes a volume of environmental noise, and the first preset condition is that the volume of the environmental noise exceeds a second threshold.

8. The earphone of claim 2, wherein the first working state is the working state in which the bone conduction vibrator operates alone, and the second working state is the working state in which the air conduction vibrator operates alone.

9. The earphone of claim 8, wherein the earphone is provided with at least one sensor for detecting at least one environmental parameter, and the control signal originates from a numerical change of the environmental parameter satisfying a second preset condition.

10. The earphone of claim 9, wherein the environmental parameter includes a liquid weight at a specific position on the earphone, and the second preset condition is that the liquid weight is less than a third threshold.

11. The earphone of claim 9, wherein the environmental parameter includes a volume of environmental noise, and the second preset condition is that the volume of the environmental noise is less than a fourth threshold.

12. The earphone of claim 2, wherein the first working state is a working state in which the bone conduction vibrator and the air conduction vibrator operate simultaneously, and the second working state is the working state in which the bone conduction vibrator operates alone or the working state in which the air conduction vibrator operates alone.

13. The earphone of claim 2, wherein the first working state is the working state in which the bone conduction vibrator operates alone or the working state in which the air conduction vibrator operates alone, and the second working state is a working state in which the bone conduction vibrator and the air conduction vibrator operate simultaneously.

14. The earphone of claim 1, wherein the bone conduction vibrator includes a first magnetic circuit, a vibration plate, and a first coil; the air conduction vibrator includes a diaphragm, a second magnetic circuit, and a second coil; and an angle between a first vibration direction of the vibration plate in the first magnetic circuit and a second vibration direction of the diaphragm in the second magnetic circuit is in a range of 45° to 135°.

15. The earphone of claim 1, wherein the bone conduction vibrator and the air conduction vibrator are located in a same housing; a vibration of the bone conduction vibrator is transmitted to a face-attaching side of the housing;
and the air conduction vibrator emits sounds through two sound guiding holes on a front side and a rear side of the diaphragm, respectively, wherein one of the two sound guiding holes faces an opening of an ear canal.

16. The earphone of claim 15, wherein each of the two sound guiding holes is provided with a waterproof breathable membrane.

17. The earphone of claim 15, wherein the earphone includes an ear hook configured to position the housing at a front side of a tragus.

18. A method for controlling an earphone, wherein the earphone includes an air conduction vibrator configured to generate an air conduction sound, a bone conduction vibrator configured to generate a bone conduction sound, and a control circuit, and the method comprises:
receiving a control signal by the control circuit; and
performing, by the control circuit and in response to the control signal, switching from a first working state of the earphone to a second working state of the earphone, wherein the first working state or the second working state includes a working state in which the bone conduction vibrator operates alone or a working state in which the air conduction vibrator operates alone.

19. (canceled)

20. The method of claim 18, wherein the earphone is provided with at least one sensor for detecting at least one environmental parameter, and the control signal originates from a numerical change of the environmental parameter satisfying a preset condition.

21-22. (canceled)

23. The method of claim 18, wherein the first working state or the second working state includes a working state in which the air conduction vibrator and the bone conduction vibrator operate simultaneously.
